(19) United States
(12) Patent Application Publication
(10) Pub. No.: US 2004/0096585 A1
(43) Pub. Date: May 20, 2004

(54) Method and device for continuously coating at least a metal strip surface with a single-layer or multilayer crosslinkable polymer fluid film

(76) Inventors: Claude Bonnebat, Pontault Cbt (FR); Jenny Frederic, Chantilly (FR); Thierry Soas, Chantilly (FR); Verhalle Richard, Asnieres S/Oise (FR)

Correspondence Address: SUGHRUE MION, PLLC, 2100 PENNSYLVANIA AVENUE, N.W., SUITE 800, WASHINGTON, DC, 20037, US

(21) Appl. No.: 10/381,850

(22) PCT Filed: Sep. 24, 2001
(86) PCT No.: PCT/FR01/02956

(30) Foreign Application Priority Data
Sep. 29, 2000 (FR) 00/12467

(51) Int. Cl. B05D 3/02; B05D 1/28

(52) U.S. Cl. 427/318; 427/428; 118/202; 118/244

(57) ABSTRACT

A method for continuously coating at least one surface of a metal strip with a single-layer or multilayer crosslinkable polymer fluid film (20) obtained from solid precursors at room temperature and free of non-reactive solvent or diluent and whereof the softening temperature is higher than 50° C. The method includes: continuously unwinding the metal strip (1); preheating the metal strip (1) at a temperature substantially equal to or higher than the crosslinkable polymer softening temperature; forming by forced flow on an applicator roll (12) with deformable surface a single-layer or multilayer coat (13) of the crosslinkable polymer; driving in rotation the applicator roll in the same direction as that of the unwinding of the metal strip (1), heating the applicator roll (12) to a temperature higher than the temperature for forming the coat; and transferring the coat onto the metal strip to form the single-layer or mutilayer film (20) on the corresponding surface of the metal strip (1). Also a coating device for implementing the method.

The present invention relates to a method for continuously coating at least one surface of a metal strip with a single-layer or multi-layer cross-linkable polymer fluid film which is obtained from precursors which are solid at room temperature and free of non-reactive solvent or diluent.

Polymers are known which are cross-linkable by thermal means, such as for example thermosetting polymers, or by physical means, such as for example photopolymerisable polymers.

There are in existence a wide range of thermosetting organic coatings which are applied continuously to metal substrates.

In the majority of cases, these are complex formulations which associate, in a solvent or aqueous medium, a system of prepolymeric functional organic binders, a cross-linking system and additives such as pigments or fillers, various formulation additives.

Equally, various methods are known for application of a thermoplastic or thermosetting organic coating to a bare or coated metal strip.

The application of the organic coatings such as for examples paints or liquid varnishes is most frequently effected by the use of a roller for application of these liquid coatings in a state of solution or dispersion in a solvent or aqueous medium.

For this the liquid coating is deposited on a metal strip by effecting a predosing of the solution or the dispersion by means of a system with two or three rollers and by transferring some or all of this liquid coating thus predosed on an applicator roller in contact with the surface of the metal strip to be coated.

The transfer is carried out either by friction of the applicator roller and the metal strip, with the two contacting surfaces running in opposite directions, or by contact in the same direction.

Furthermore, it is common to apply a film formed of several successive coats of paint or varnish which have strong affinities with one another in terms of their adhesion but have different functionalities for the decoration or the anti-corrosion protection of this metal strip.

The first coat is generally called the primer and the second coat or visible coat is called the top coat.

The primer generally has the specific purpose of obtaining an excellent adhesion with the metal strip and inhibiting corrosion of this strip, which can be achieved by incorporation of an organic or inorganic pigment or by the addition of particles of a metal which is more oxidisable than the substrate.

An opacifying pigment can also be incorporated into this primer.

In so far as the top coat is concerned, it permits the addition of pigments or colouring agents in order to obtain a uniform shade as well as the use of binders with a very good photochemical resistance or the incorporation of ultraviolet absorbers or free radical inhibitors. This top coat also enables a homogeneous structured surface to be produced in order to obtain the “orange peel” effect. Finally, it also permits the addition for example of lubricants, anti-marking additives or non-scratch treatment.

The coating film can also include one or several intermediate coats which, in general, give thickness to this film with economical formulations and the said intermediate coat can also be used as a barrier to light in order to protect the primer from photodegradation under a top coat which is partially transparent to ultraviolet light.

For the application of this type of single-layer or multi-layer organic coating it is common to use formulations of paint varnish which have a low viscosity and are based on solutions or dispersions, binders and dispersions of mineral filler in solvents, in water or in mixed systems.

These dispersions or solutions then have a level of viscosity which is not very high in the intense shear conditions of the system for application of paint or varnish, for example 0.5 Pa.s, and can be easily applied with a roller which is a commonly used technique.

However, in the case of a multi-layer coating, the application with a roller does not allow the superimposition of several so-called “moist” coats, that is to say before polymerisation, nor simultaneous curing thereof, which renders the method of continuous coating of metal strips more complex for two essential reasons.

In fact, the method of application with a roller necessitates a step of adjustment of the thickness which is most often carried out by squeezing the fluid between a dosing roller and an applicator roller, which does not therefore permit the application of one “moist” coat on top of another so-called “moist” coat.

Furthermore, it is difficult to dry coats with great thicknesses without causing the appearance of blistering defects which are manifested in particular due to the fact that volatile substances continue to escape within the primer coat whilst the top coat is already closed.

The development of techniques for application of a film to an unwinding metal strip permits the use of cross-linkable polymers which do not contain any solvent or non-reactive diluent, and there is in existence a wide variety of thermosetting organic coatings which are applied continuously to metal substrates.

Amongst the techniques used for coating a metal strip with a cross-linkable polymer film which is obtained from precursors solid at room temperature and free of non-reactive solvent or diluent, there is known for example the technique of strip powdering, application by a solid block of paint.

However, the implementation of these different techniques poses a double problem, that of producing a homogeneous dispersion of the fillers or the pigments in the binder system and that of application of the product thus obtained.

In the case of a system based on powder, it is difficult to produce deposits of fine thickness and the superimposition of several cross-linked coats in one single melting and curing operation.

In so far as the application of paint in the form of a solid block is concerned, this is a technique which is not adapted to the application of several superimposed coats because of the use of a smoothing roller which serves as a homogenising system.

There is also known another technique for application of a liquid coating on a metal strip which uses a heating tank commonly called a melter, which is provided in its lower part with an opening for the outflow of the liquid polymer contained in the tank.

Below this tank are disposed two parallel rolls which are in contact with one another and the metal strip to be coated moves below these rolls.

The liquid polymer is discharged at the level of the gap between the rolls, then flows between the said rolls and is deposited on the metal strip.

The technique of extrusion is currently used in the field of transformation of thermoplastic materials in the molten state in order to produce single-layer or multi-layer deposits.

This technique is used in particular for the manufacture of multi-layer films by coating on metal rollers or for coating substrates such as paper or cardboard or even plastics films.

Metal/polymer associations may be produced by forming a film or a layer of molten polymer which is first of all drawn in the air, then flattened between a cold roll and the unwinding metal strip.

The technique of coextrusion of multi-layer thermoplastic organic coatings is described in particular in EP-A-067 060 for the application of polyolefins of which the adhesion on the thick metal substrate is achieved by coextrusion of an appropriate adhesive.

Another possible mode of application of a molten thermoplastic coating film to a preheated metal strip which is being unwound consists of forming a layer in a nozzle or a die positioned close to the metal strip and applying it directly to the strip without a self-supported aerial path, the molten material ensuring a contact between the lips of the nozzle or of the die and the surface of the metal strip.

However, the application by this technique of a cross-linkable polymer fluid film produced from precursors which are solid at room temperature and free of solvent or non-reactive diluent cannot be achieved in a satisfactory manner by a direct deposit on the strip in the case where the metal substrate is relatively thick.

In fact, the irregularity of a metal surface due to defects of flatness and its variations of thickness become too great so that the layer which is formed, calibrated by the distance between the surface of the nozzle and that of the metal strip, shows substantial variations of thickness relative to its average thickness, particularly if attempts are made to produce deposits with a thickness of less than 50 μm.

In general, the different known application techniques do not make it possible to compensate for the variations in thickness of the metal substrate, which consequently induce unacceptable fluctuations in the thickness of the coating particularly in the case where the substrate is formed by a metal strip which has a roughness and/or substantial ripples on the surface of an amplitude equal to or greater than the thickness of the coating to be produced on the said metal strip.

Moreover, these different application techniques do not make it possible to accommodate variations in the width of the substrate, nor variations of transverse positioning of this substrate, such that the coating cannot be deposited in a uniform manner over all the width of the substrate.

Finally, during the application of the coating, microbubbles of air can be interposed between the coating and the substrate, which prejudices the homogeneous application and the surface appearance of this coating.

Thus, the continuous application of a single-layer or multi-layer cross-linkable polymer coating which is of small thickness and is uniform on a metal strip which is being unwound poses problems due to the fact that this metal strip has defects of flatness and of thickness as well as a roughness and/or substantial ripples, even when this strip is flattened under high tension on a uniform roll.

The object of the invention therefore is to avoid these drawbacks by proposing a method and device for continuous coating of at least one surface of a metal strip with a cross-linkable polymer fluid film obtained from precursors which are solid at room temperature and free of solvent or non-reactive diluent and whereof the softening temperature is higher than 50° C., making it possible to obtain in one single step a uniform coating with homogeneous structured surface of several microns to several tens of microns applied in a homogeneous manner to this strip, whilst avoiding the interposition of microbubbles of air between the film and the metal strip and eliminating defects of flatness and of roughness of this strip.

The invention relates to a method of continuous coating of at least one surface of a metal strip with a single-layer or multi-layer cross-linkable polymer fluid film obtained from precursors which are solid at room temperature and free of solvent or non-reactive diluent and whereof the softening temperature is higher than 50° C., the said film having a thickness less than that of the metal strip, characterised in that:

the metal strip is unwound continuously,

the metal strip is preheated to a temperature equal to or higher than the softening temperature of this cross-linkable polymer,

on an applicator roll with a deformable surface and by forced flow at a temperature higher than the softening temperature of the cross-linkable polymer, a layer of the said cross-linkable polymer is formed in the molten state having a viscosity higher than 10 Pa.s under the conditions of formation of this layer,

the applicator roll is driven in rotation in the same direction as the direction of unwinding of the metal strip,

the applicator roll is heated to a temperature higher than the temperature of formation of the layer,

in the course of the transfer of the layer on the applicator roll, the cross-linkable polymer is thermally conditioned using methods adapted to lower the viscosity of this cross-linkable polymer to a value lower than the said viscosity measured under the conditions of the said forced flow,

the layer is compressed between the surfaces of the applicator roll and the metal strip, and

the layer is divided by sharing it in a controlled manner during the separation of the surfaces of the applicator roll and of the strip in order to coat the corresponding face of the said strip and to obtain a coating with a homogeneous structured surface.

The invention also relates to a device for continuous coating of at least one surface of a metal strip with a single-layer or multi-layer cross-linkable polymer fluid film obtained from precursors which are solid at room temperature and free of solvent or non-reactive diluent and whereof the softening temperature is higher than 50° C., the said film having a thickness less than that of the metal strip, characterised in that it comprises:

means for continuous driving of the metal strip,

means for preheating the metal strip to a temperature equal to or higher than the softening temperature of this cross-linkable polymer,

means for forming, on an applicator roll with a deformable surface and by forced flow at a temperature higher than the softening temperature of the cross-linkable polymer, a layer of the said cross-linkable polymer in the molten state having a viscosity higher than 10 Pa.s under the conditions of formation of this layer,

means for driving the applicator roll in rotation in the same direction as the direction of unwinding of the metal strip,

means for heating the applicator roll to a temperature higher than the temperature of formation of the layer,

means for thermally conditioning, in the course of the transfer of the layer on the applicator roll, the cross-linkable polymer using methods adapted to lower the viscosity of this cross-linkable polymer to a value lower than the said viscosity measured under the conditions of the said forced flow,

means for compressing the metal strip against the applicator roll in order to effect a partial transfer in thickness of the layer from this roll to a face of the metal strip, and

means for separating the layer into a part remaining on the applicator roll and a part transferred to the corresponding face of the metal strip in order to coat the said face of the said strip with cross-linkable polymer and to obtain a coating with a homogeneous structured surface.

The characteristics and advantages of the invention will become apparent in the course of the following description which is given solely by way of example and with reference to the accompanying drawings, in which:

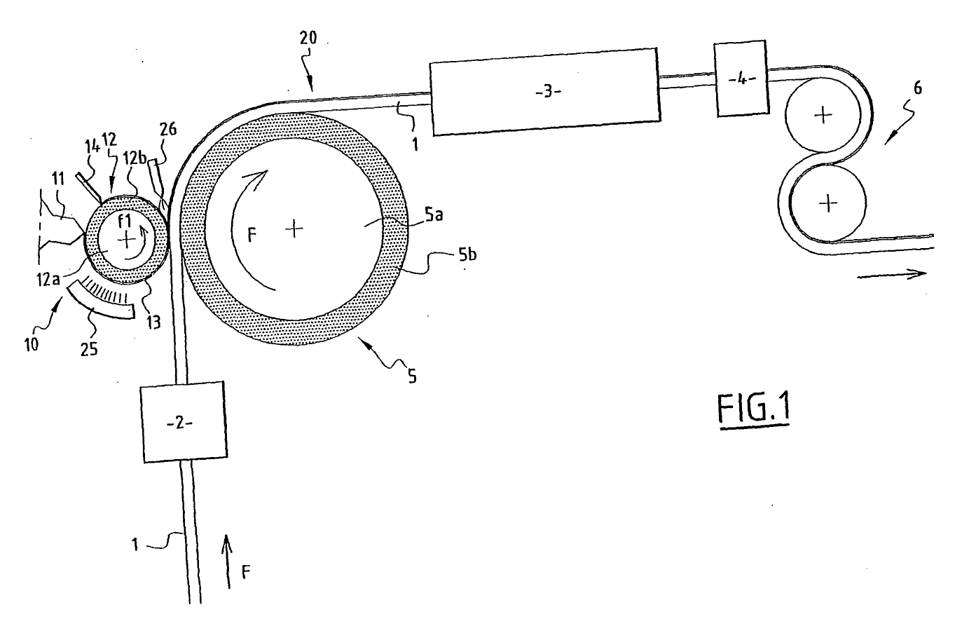

FIG. 1 is a schematic sectional view of an installation for coating one face of a metal strip with a cross-linkable polymer fluid film including a device for application of this coating in accordance with the invention,

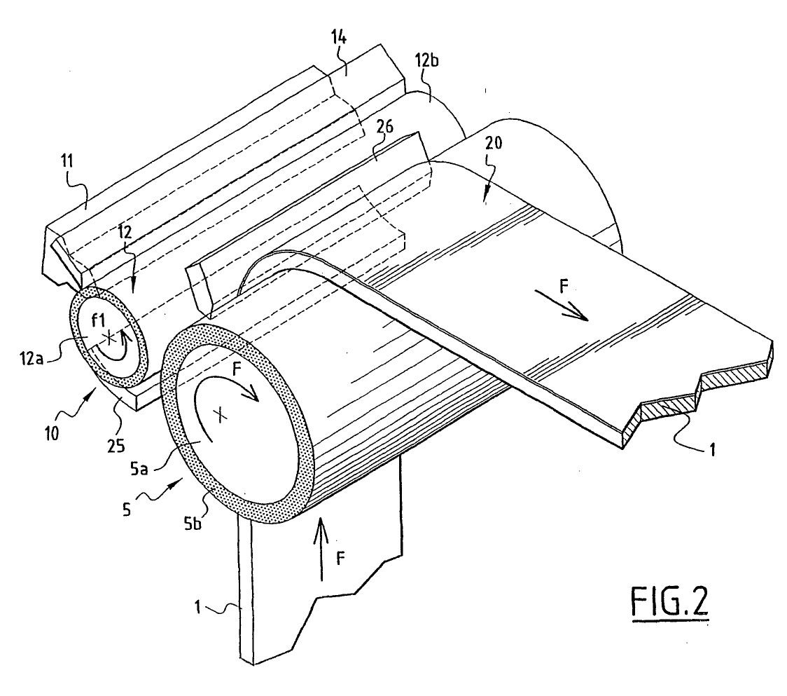

FIG. 2 is a schematic perspective of application according to the invention,

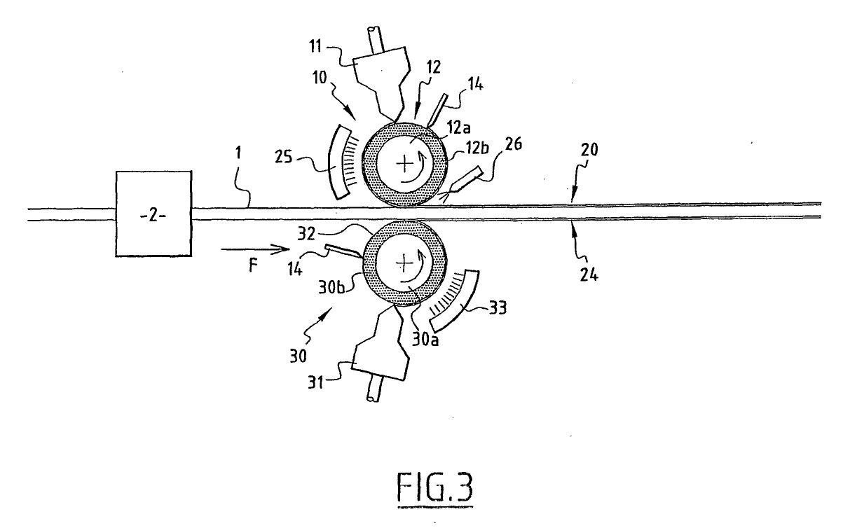

FIG. 3 is a schematic sectional view of a first variant of the device for application according to the invention,

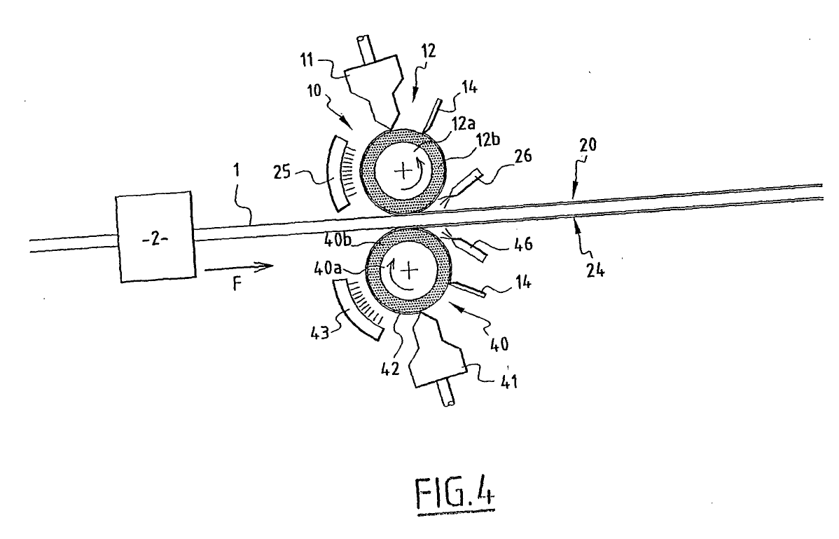

FIG. 4 is a schematic sectional view of a second variant of the device for application according to the invention,

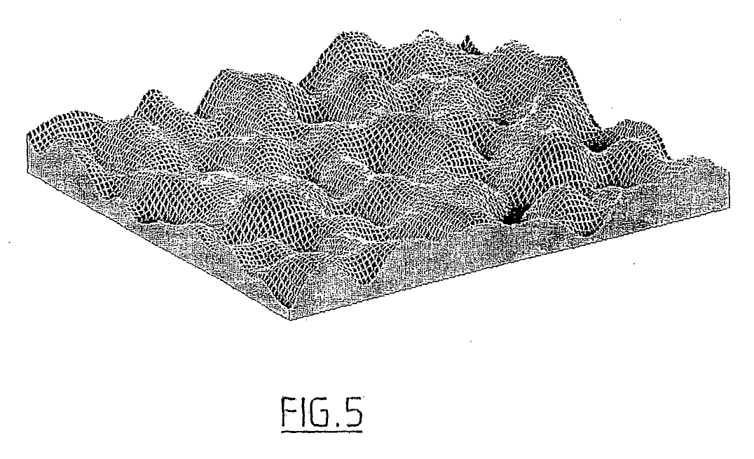

FIG. 5 is a perspective view on an enlarged scale of the homogeneous structured surface of the coating obtained by the method according to the invention.

FIG. 1 shows schematically an installation for continuous coating of a metal strip 1 with a single-layer or multi-layer cross-linkable polymer film 20 obtained from precursors which are solid at room temperature and free of solvent or non-reactive diluent and with a thickness between 5 and 50 μm. In this drawing the thickness of the strip 1 has been exaggerated in order to differentiate it from the film.

This metal strip 1 has a thickness of for example between 0.10 and 4 mm and is made for example from steel or from aluminium or even from an aluminium alloy.

The polymer of each coat can be different and this polymer used in order to coat the metal strip 1 is obtained from precursors which are solid at room temperature and free of solvent or non-reactive diluent and are cross-linkable by thermal means, such as for example a thermosetting polymer, or by physical means, such as for example a photopolymerisable polymer. In the non-cross-linked state this polymer has a softening temperature higher than 50° C.

This polymer also has temperatures of softening, of onset of flow, of onset of cross-linking and of rapid cross-linking which are different.

In general, the temperature of onset of cross-linking is the temperature above which an increase in the viscosity higher than 10% in less than 15 minutes is observed.

In the case of a polymer which is cross-linkable under radiation, there is no temperature limit in order to reduce its viscosity in the absence of radiation. It is therefore easier to heat the polymer at the level of the application system in order to reduce its viscosity without the risk of causing the onset of cross-linking.

The metal strip 1 is driven so that it unwinds in the direction of the arrow F and the installation has means 2 for preheating the metal strip 1 to a temperature equal to or higher than the temperature of the cross-linkable polymer fluid film 20 to be deposited on the said metal strip 1 and the softening temperature of this cross-linkable polymer.

The means 2 for preheating of the metal strip 1 are formed for example by at least one induction oven.

As shown in FIG. 1, the installation includes, from the top downwards,

a device designated as a whole by the reference numeral 10 for coating of the metal strip 1 with the cross-linkable polymer film 20 obtained from precursors which are solid at room temperature and free of solvent or non-reactive diluent and whereof the softening temperature is higher than 50° C.,

means 3 for curing or cross-linking of the cross-linkable polymer film, and

a block 6 for traction of the metal strip 1.

In the case where the polymer is cross-linkable by thermal means, the curing means 3 include for example at least one induction oven and the cooling means 4, and in the case where the polymer is cross-linkable by physical means, the curing means 3 may comprise lamps or electron beams.

In the embodiment illustrated in FIGS. 1 and 2, the metal strip is resting on at least one support roll 5 having a metal central core Sa, made for example from steel, and an outer casing 5b made from a deformable material, such as for example elastomer. Other embodiments of the support roll 5 may be envisaged, such as for example a roll with a metal coating.

The cross-linkable polymer film 20 to be deposited on the metal strip 1 must have a uniform thickness even though this metal strip 1 may be heterogeneous in thickness or may have defects of flatness as well as a roughness and substantial ripples on the surface of an amplitude equal to or greater than the thickness of the film 20 deposited on the metal strip 1.

The film 20 is either a single-layer film or a multi-layer film.

In the case of a multi-layer film, the film 20 has at least two coats, a so-called primer coat and a top coat.

The primer coat is for example an anti-corrosion coat and the top coat permits a uniform shade to be obtained by the addition of pigments or colouring agents and/or the incorporation of ultraviolet absorbers and/or free radical inhibitors.

In addition to these two coats, the film 20 can also include one or several intermediate coats used for example used as a barrier to light in order to protect the primer from photodegradation under a top coat which is partially transparent to ultraviolet light and, in general, this layer or these layers give(s) thickness to the film 20.

The device for coating one face of the metal strip 1 includes:

means 11 for forming, on an applicator roll 12 with a deformable surface and by forced flow at a temperature higher than the softening temperature of the cross-linkable polymer, a layer 13 which is homogeneous and of uniform thickness of the said cross-linkable polymer in the molten state having a viscosity higher than 10 Pa.s under the conditions of formation of this layer,

means for driving the applicator roll 12 in rotation in a direction f1 identical to the direction of unwinding of the metal strip 1,

means 25 for thermally conditioning, in the course of the transfer of the layer 13 on the applicator roll 12, the cross-linkable polymer using methods adapted to lower the viscosity of this cross-linkable polymer to a value lower than the said viscosity measured under the conditions of the said forced flow,

and means for compressing the metal strip 1 against the applicator roll 12 in order to effect a partial transfer in thickness of the layer 13 from this applicator roll 12 to a face of the metal strip 1.

Depending upon the nature of the film 20 to be obtained on the metal strip 1, the layer 13 comprises one coat of cross-linkable polymer or several superimposed coats of cross-linkable polymer in the molten state and of different natures.

The applicator roll 12 comprises a metal central core 12a, made for example from steel, and an outer casing 12b made from a deformable material, such as for example elastomer.

The means for forming the coat 13 by forced flow comprise at least one extrusion nozzle 11 connected to means (not shown) for supplying molten cross-linkable polymer.

A particular feature of extrusion nozzles is that they permit a wide variety of methods of regulation for application of the layer 13 on the applicator roll 12 by adjusting the position or the pressure of the nozzle 11 relative to the said cylinder 12 or by modifying the inclination of the front face of the said nozzle 11 relative to the normal at the point of contact with the roll 12 or by choosing the geometry of the lips of the said extrusion nozzle 11.

The applicator roll 12 is heated to a temperature higher than the temperature of formation of the layer 13 and is driven in rotation by appropriate means (not shown) in the same direction as the direction of unwinding of the metal strip 1.

In the case of a multi-layer film, the prior formation of the multi-layer layer 13 in the molten state on the applicator roll 12 is achieved by different methods.

The first consists of carrying out successive applications of the different layers which make up the layer 13 in several steps with separate extrusion nozzles.

Furthermore, it is necessary to avoid the creation of turbulence during the application of the second layer and any further layers on the first layer.

A second possibility consists of successively applying two layers of the layer 13 with one single extrusion nozzle 11 having two distinct feed slots.

A third possibility consists of simultaneously applying the two layers, already superimposed in the extrusion nozzle 11.

At the outlet of the extrusion nozzle 11, the layer 13 of cross-linkable polymer in the molten state is deposited on the applicator roll 12 in such a way that the top coat is directly in contact with the outer surface of the applicator roll 12 and the primer coat is above the said top coat.

In the course of its transfer on the applicator roll 12, the polymer of the layer 13 is thermally conditioned in order to lower the viscosity of this polymer in order to facilitate its transfer and its application on the metal strip 1.

The methods of thermal conditioning are adapted in order to lower the viscosity of the cross-linkable polymer by at least a factor of 2, and the temperature of the said cross-linkable polymer may possibly exceed the temperature of onset of cross-linking of this polymer.

Thus, in spite of the increase in the temperature of the cross-linkable polymer to a level usually considered to be likely to cause the onset of cross-linking and thus an increase in the viscosity, this viscosity maintains a very low level, at least temporarily, facilitating the transfer and the application of the layer 13 of cross-linkable polymer to the metal strip 1.

The means for thermal conditioning of the cross-linkable polymer are formed for example by a system of internal heating of the applicator roll 12 and/or by at least one source 25 of application of a complementary thermal flux to the layer 13.

The system for internal heating of the applicator roll 12 comprises for example electrical resistors embedded in the mass of this roll or of channels provided in the said roll for the circulation of a heat-exchanging fluid, such as for example oil.

The internal temperature of the applicator roll 12 must be regulated, for example by means of a thermocouple (not shown), so that it does not exceed a limiting value in order to prevent the external casing 12b made from deformable material from being damaged by a temperature which is too high and to prevent deterioration of the bonding layer between the deformable material and the metal core of the said applicator roll 12.

Immediately before it passes against the applicator roll 12, the metal strip 1 is held at a temperature equal to or higher than the softening temperature of the cross-linkable polymer, and for example this metal strip 1 is pre-heated to a temperature of the order of 140° C.

According to the first embodiment illustrated in FIG. 1, the metal strip 1 is compressed against the applicator roll 12 by means of the support roll 5.

Due to this pressure the layer 13 is compressed between the surfaces of the applicator roll 12 and the metal strip 1. At the moment of separation one part of this layer 13 remains on the applicator roll 12 whilst the other part of this layer 13 is transferred to the corresponding face of the metal strip 1 in order to coat the said face with the film 20 of cross-linkable polymer and to obtain a coating with a homogeneous structured surface.

At the moment of separation of the layer 13, filaments form between the part resting on the applicator roll 12 and the part transferred to the face of the metal strip 1.

In order for this split to take place under controlled conditions, it is necessary on the one hand to control the relative distribution of the material between the applicator roll 12 and the strip 1 and on the other hand to control the instabilities which arise during the separation of the two parts of the layer 13.

The coating device comprises means 26 for controlling the morphology of the surfaces during the separation of the part of the layer 13 resting on the applicator roll 12 from the part of the layer 13 on the corresponding face of the metal strip 1.

These means 26 are intended either to eliminate the filaments forming during the separation of the layer 13 or to interrupt the propagation of their drawing into the zone of separation of the said layer 13.

These means 26 are constituted for example by a nozzle for suction of the filaments formed between the two parts of the layer 13 or by a nozzle for blowing hot air in order to flatten the filaments on the applicator roll or by a transverse wire to break the said filaments.

These elements extend over the entire length of the gap between the applicator roll 12 and the metal strip 1.

The quantity of material returning on the applicator roll 12, that is to say the thickness of the part of the layer 13 remaining on this applicator roll, is minimised by acting on different parameters.

A first parameter consists of adjusting the speed differential between the applicator roll 12 and the metal strip 1 and in particular adjusting the tangential speed of the applicator roll 12 in a ratio of between 0.2 and 2 times the speed of unwinding of the metal strip 1.

In fact, if the speed of the applicator roll 12 is less than the speed of the strip 1, the structured appearance of the film 20 is finer and the thickness of the part of the layer 13 transferred to the face of the metal strip 1 is more substantial whilst the part of the layer 13 remaining on the applicator roll 12 is minimised. On the other hand, if the speed of the applicator roll 12 is greater than the speed of the metal strip 1, the structured appearance of the film 20 is more coarse.

Another parameter consists of modifying the temperature differential of the applicator roll 12 relative to the temperature of the metal strip 1.

If the temperature of the applicator roll 12 is higher than the temperature of the metal strip 1, the material becomes detached more easily from this applicator roll 12 in order to go onto the metal strip 1 which is cooler.

A last parameter consists of reducing the surface energy of the applicator roll 1 in such a way as to facilitate the detachment of the material from the said applicator roll 12.

By way of example, the bearing force of the applicator roll 12 on the metal strip 1 at the level of the gap is between 300 and 500 daN/m.

The other face of the metal strip 1 can be bare or pre coated with a coating adapted to the use of this metal strip 1.

Next the metal strip 1 thus coated passes into the curing means 3, then into the means 4 for cooling of the film 10 of cross-linkable polymer.

The coating thus produced on the metal strip 1 has for example a thickness of between 5 and 50 μm with a uniformity of thickness of several microns in spite of the perceptible defects of flatness or of heterogeneity of thickness of the metal strip 1.

As represented on the typical topography of FIG. 5, the coating obtained on the face of the metal strip has a homogeneous structured surface comprising a regular alternation of hollows and bumps.

This morphology is not influenced very much by the speed or temperature differential between the applicator roll 12 and the strip 1.

On the other hand, when the ratio between the speed of the applicator roll (applicator speed) and that of the strip (strip speed) increases, the difference in height between the hollows and the bumps increases greatly, the “structured” appearance become more and more coarse.

| applicator speed | strip speed | applicator speed/ | difference in height |
|---|---|---|---|
| (m/min) | (m/min) | strip speed | hollows [symbol] bumps (μm) |
| 5 | 12 | 0.4 | 15 |
| 10 | 10 | 1 | 30 |
| 12 | 8 | 1.3 | 50 |

Moreover, the cross-linkable polymer remaining on the applicator roll 12 can be re-injected below the layer 13 at the outlet of the extrusion nozzle 11.

In order to facilitate this reintroduction of the excess polymer into the layer 13, the extrusion nozzle 11 can be adjusted by adjusting the angle of attack relative to a plane passing through the axis of the applicator roll 12 and the generating line of application of the said layer 13 on the outer surface of the said applicator roll 12.

According to another variant, the excess of cross-linkable polymer can be eliminated by a doctor blade 14, made for example from metal, in contact with the applicator roll 12.

The layer 13 and the film 20 of cross-linkable polymer may have a width less than the width of the metal strip 1 so as to coat only a part of this metal strip 1 or a width greater than the width of this metal strip in order to coat all of the said metal strip 1.

In the case where the layer 13 and the film 20 have a width greater than the metal strip 1, a portion of cross-linkable polymer which is not applied to the metal strip remains on either side of the useful application zone of the said metal strip 1. This excess of cross-linkable polymer is removed by the doctor blade 14.

Moreover, the transverse position of the extrusion nozzle 11 can be centred permanently with respect to the metal strip 1 as a function of the variations of the transverse position of this metal strip 1, for example by disposing this extrusion nozzle 11 on transversely movable support.

In FIGS. 3 and 4 two variants are shown which comprise means for simultaneously coating the two faces of the metal strip 1 with a cross-linkable polymer fluid film obtained from precursors which are solid at room temperature and free of solvent or non-reactive diluent, whereof the softening temperature is higher than 50° C.

In these two embodiments, the first face of the metal strip 1 is coated with a single-layer or multi-layer film 20 by means of a device 10 which is identical to the previous embodiment and comprises an extrusion nozzle 11, an applicator roll 12, means 25 for thermal conditioning of the layer 13 of cross-linkable polymer formed on the applicator roll 12 and means 26 for separation of the part of the layer 13 remaining on the applicator roll 12 from the part of the layer 13 transferred to the corresponding face of the metal strip 1.

According to the embodiment shown in FIG. 3, the means for compression of the metal strip 1 against the applicator roll 12 are formed by a second applicator roll 30 for example with a deformable surface and driven in rotation in the opposite direction to the direction of unwinding of the metal strip 1.

The second applicator roll 30 has a metal core 30a covered with a casing 30b made from deformable material, such as for example an elastomer.

Associated with the second applicator roll 30 are means 31 for formation, by forced flow at a temperature higher than the softening temperature of the cross-linkable polymer, of a layer 32 of the said cross-linkable polymer in the molten state and having a viscosity higher than 10 Pa.s under the conditions of formation of this layer.

The means for formation of the layer 32 comprise an extrusion nozzle 31 connected to means (not shown) for supplying cross-linkable polymer.

The layer 32 is formed either by a single-layer coat or by a multi-layer coat comprising at least one primer coat and one top coat and possibly one or several intermediate coats between the said primer coat and the said top coat.

In the course of its transfer to the second applicator roll 30, the viscosity of this layer 32 is lowered in order to facilitate the transfer and application thereof to the metal strip 1.

For this, the second applicator roll 30 is associated with means 33 for thermal conditioning of the cross-linkable polymer which are formed for example by a system of internal heating of the second applicator roll 30 and/or by a system of external heating of this second applicator roll 30 for example by at least one source 33 of application of a complementary thermal flux to the layer 32.

In this case the transfer of the layer 32 of cross-linkable polymer to the other face of the metal strip 1 is total, which makes it possible to coat this face with a single-layer or multi-layer cross-linkable polymer film 24 and to obtain a coating with a homogeneous thickness and smooth surface.

According to the second embodiment shown in FIG. 4, the means for pressing the metal strip 1 against the applicator roll 12 are formed by a second applicator roll 40, which for example has a deformable surface and is driven in rotation in the same direction as the direction of unwinding of the metal strip 1.

The second applicator roll 40 has a metal core 40a covered with a casing 40b made from deformable material, such as for example an elastomer.

Associated with the second applicator roll 40 are means 41 for formation, by forced flow at a temperature higher than the softening temperature of the cross-linkable polymer, of a layer 42 of the said cross-linkable polymer in the molten state and having a viscosity higher than 10 Pa.s under the conditions of formation of this layer.

The means for formation of the layer 42 comprise an extrusion nozzle 41 connected to means (not shown) for supplying cross-linkable polymer.

The layer 42 is formed either by a single-layer coat or by a multi-layer coat comprising at least one primer coat and one top coat and possibly one or several intermediate coats between the said primer coat and the said top coat.

In the course of its transfer to the second applicator roll 40, the viscosity of this layer 42 is lowered in order to facilitate the transfer and application thereof to the corresponding face of the metal strip 1.

For this, the second applicator roll 40 is associated with means for thermal conditioning of the cross-linkable polymer which are formed for example by a system of internal heating of the second applicator roll 40 and/or by a system of external heating of this second applicator roll 40 for example by at least one source 43 of application of a complementary thermal flux to the layer 42.

In this case the layer 42 is transferred partially to the corresponding face of the metal strip 1 by the second applicator roll 40 in such a way as to coat this face with a film 44 of cross-linkable polymer and to obtain a coating with a homogeneous structured surface, that is to say having an “orange peel” surface appearance. This film 44 may be a single-layer film or a multi-layer film.

In this case equally the device comprises means 46 for separation of the part of the layer 42 remaining on the applicator roll 40 from the part of the layer 42 transferred to the corresponding face of the metal strip 1.

These means are formed for example by a nozzle for suction of the filaments or by a nozzle for blowing hot air in order to flatten the filaments on the applicator roll 40 or by a transverse wire to break these filaments.

The temperature of the applicator roll 40 can also be adjusted in order to increase or decrease the thickness of the part of the layer 42 transferred to the corresponding face of the metal strip 1 and the tangential speed of the applicator roll 42 can also be adjusted within a ratio between 0.2 and 2 times the speed of unwinding of the metal strip 1 in order also to increase or decrease the thickness of the part of the layer 42 transferred to the corresponding face of the said metal strip 1.

The excess of cross-linkable polymer remaining on the applicator roll 42 may be re-injected below the layer 42 at the outlet of the extrusion nozzle 41.

Moreover, the applicator rolls 30 and 40 can also be equipped like the applicator roll 12 with means constituted for example by a doctor blade 14 for removing the excess of cross-linkable polymer deposited on these cylinders.

The coating device also comprises means (not shown) for adjustment of the contact pressure between the metal strip 1 and the applicator rolls 12, 30 and 40 and the support roll 5. These means comprise for example hydraulic jacks or screw/nut systems which permit adjustment of the contact pressures in such a way as to ensure a transfer of the material under the best conditions.

Preferably, in the case where the coating deposited on one or both faces of the metal strip is formed by a multi-layer coating, the top coat is thicker than the primer coat.

By way of example, the composition of the thermosetting organic coating is as follows:

| | |
|---|---|
| polyester resin (hydroxylated) | 55% |
| uretdione setting agent (blocked isocyanate) | 10% |
| pigment TiO₂ (for white formulation) | 30% |
| additives: agent for spreading, catalysis, | 5% |
| cross-linking, shade adjustment | |

The characteristics of this thermosetting organic coating are for example:

| | | | | | | |
|---|---|---|---|---|---|---|
| Temperature (° C.) | 110 | 120 | 130 | 140 | 150 | 160 |
| Viscosity (Pa · s) | 200 | 125 | 70 | 40 | 20 | 10 |
| on the Newtonian scale | | | | | | |

Tg: 25° C. (before cross-linking); 40° C. (after cross-linking)

Average molecular weight: Mn: 4000 g/mol

For example, the layer of molten cross-linkable polymer at the outlet of the extrusion nozzle has a temperature of 125° C. and the thermal conditioning brings the temperature of the cross-linkable polymer on the applicator roll 12 for example to 155° C. by the thermal conditioning means and the metal strip 1 is preheated to a temperature for example of 140° C.

The coating device according to the invention makes it possible to obtain on a metal strip a coating of cross-linkable polymer with a uniform average thickness and controlled morphology on a metal strip which has a substantial roughness and defects of flatness and of heterogeneity of thickness.

The coating device according to the invention offers the possibility of being able to carry out in one single operation the application and the curing of the different organic coatings, which makes it, possible to make considerable reductions in the investment costs as well as the production costs.

Thus this device considerably increases the flexibility of the production lines which are not limited by the number of coats or by their thickness.

Moreover, the fact that the temperature of formation of the layer is lower than the temperature of cross-linking of the polymer is an important characteristic in the case of thermosetting polymers, since otherwise the forced flow through the extrusion nozzle can cause substantial stagnation of the polymer which can spoil the good distribution of this polymer over the entire width of this nozzle.

Finally, the device according to the invention makes it possible to compensate for fluctuations in the width or the transverse position of the metal strip during application and to eliminate defects of uniformity of the metal strip and thus to produce a coating with a uniform thickness on a non-uniform metal substrate.

It also permits continuous coating of metal strips of different widths or simultaneous coating of several metal strips disposed parallel alongside one another, and permits by simple and effective means elimination of fluctuations in width and positioning of the metal strip or strips.

1. Method of continuous coating of at least one surface of a metal strip (1) with a cross-linkable polymer fluid film (20) obtained from precursors which are solid at room temperature and free of solvent or non-reactive diluent and whereof the softening temperature is higher than 50° C., the said film (20) having a thickness less than that of the metal strip (1), characterised in that:
the metal strip (1) is unwound continuously,
the metal strip (1) is preheated to a temperature equal to or higher than the softening temperature of this cross-linkable polymer,
on an applicator roll (12) with a deformable surface and by forced flow at a temperature higher than the softening temperature of the cross-linkable polymer, a layer (13) of the said cross-linkable polymer is formed in the molten state having a viscosity higher than 10 Pa.s under the conditions of formation of this layer,
the applicator roll (12) is driven in rotation in the same direction as the direction of unwinding of the metal strip (1),
the applicator roll (12) is heated to a temperature higher than the temperature of formation of the layer (13),
in the course of the transfer of the layer (13) on the applicator roll (12), the cross-linkable polymer is thermally conditioned using methods adapted to lower the viscosity of this cross-linkable polymer to a value lower than the said viscosity measured under the conditions of the said forced flow,
the layer (13) is compressed between the surfaces of the applicator roll (12) and the metal strip (1), and
the layer (13) is divided by sharing it in a controlled manner during the separation of the surfaces of the applicator roll (12) and of the metal strip (1) and to obtain a coating with a homogeneous structured surface.

2. Method of coating as claimed in claim 1, characterised in that the metal strip (1) is compressed between the said applicator roll (12) and a support roll (5) with a deformable or non-deformable surface.

3. Method of coating as claimed in claim 1, characterised in that:
the metal strip (1) is compressed between the said applicator roll (12) and a second applicator roll (30) with a deformable surface which is driven in rotation in the opposite direction to the direction of unwinding of the metal strip (1),
on the second applicator roll (30) and by forced flow at a temperature higher than the softening temperature of the cross-linkable polymer, a layer (32) of the said cross-linkable polymer is formed in the molten state having a viscosity higher than 10 Pa.s under the conditions of formation of this layer (32),
in the course of the transfer of the layer (32) on the second applicator roll (30), the cross-linkable polymer is thermally conditioned using methods adapted to lower the viscosity of this cross-linkable polymer to a value lower than the said viscosity measured under the conditions of the said forced flow,
a total transfer in thickness of the layer (32) from the second applicator roll (30) to the other face of the metal strip (1) is effected in order to coat this face with a film (24) of cross-linkable polymer and to obtain a coating with a homogeneous thickness and a smooth surface.

4. Method of coating as claimed in claim 1, characterised in that:
the metal strip (1) is compressed between the said applicator roll (12) and a second applicator roll (40) with a deformable surface which is driven in rotation in the same direction as the direction of unwinding of the metal strip (1),
on the second applicator roll (40) and by forced flow at a temperature higher than the softening temperature of the cross-linkable polymer, a layer (42) of the said cross-linkable polymer is formed in the molten state having a viscosity higher than 10 Pa.s under the conditions of formation of this layer (42),
the second applicator roll (40) is heated to a temperature higher than the temperature of formation of the layer (42),
in the course of the transfer of the layer (42) on the second applicator roll (40), the cross-linkable polymer is thermally conditioned using methods adapted to lower the viscosity of this cross-linkable polymer to a value lower than the said viscosity measured under the conditions of the said forced flow,
the layer (42) is compressed between the surfaces of the second applicator roll (40) and the other face of the metal strip (1), and
the layer (42) is divided during the separation of the surfaces of the second applicator roll (40) and of the other face of the strip (1) by dividing it into a part remaining on the said second applicator roll (40) and a part transferred to the said face in order to coat this face with a film (44) of cross-linkable polymer and to obtain a coating with a homogeneous structured surface.

5. Method of coating as claimed in any one of claims 1 to 4, characterised in that the or each film (20; 24; 44) of cross-linkable polymer deposited on the face of the metal strip (1) by means of the or each applicator roll (12; 30; 40) is formed from a single-coat layer (13; 32; 42).

6. Method of coating as claimed in any one of claims 1 to 4, characterised in that the or each film (20; 24; 44) of cross-linkable polymer deposited on the face of the metal strip (1) by means of the or each applicator roll (12; 30; 40) is formed from a multi-coat layer (13; 32; 42) comprising at least one primer coat and one top coat.

7. Method of coating as claimed in claim 1 or 4, characterised in that the thickness of the part of the or each layer (13; 42) transferred to the corresponding face of the metal strip (1) is increased or decreased relative to the part of the layer (13; 42) remaining on the or each applicator roll (12; 40) by varying the temperature differential between the said applicator roll (12; 40) and the metal strip (1) and/or the speed differential between the said applicator rolls (12; 40) and the speed of the metal strip (1) and/or the pressure exerted by the said applicator roll (12; 40) on this metal strip (1).

8. Method of coating as claimed in any one of the preceding claims, characterised in that the methods are adapted in order to lower the viscosity of the cross-linkable polymer by at least a factor of 2.

9. Method of coating as claimed in any one of the preceding claims, characterised in that the cross-linkable polymer is thermally conditioned by heating of the or each applicator roll (12; 30; 40) and/or by application to the or each layer (13; 32; 42) of a complementary thermal flux.

10. Method of coating as claimed in any one of claims 1, 3 or 4, characterised in that the or each layer (20; 13; 32; 42) is formed by extrusion.

11. Method of coating as claimed in any one of the preceding claims, characterised in that the or each layer (13; 32; 42) of cross-linkable polymer is formed with a width less than the width of the metal strip (1) in order to coat only a part of the corresponding face of this metal strip (1).

12. Method of coating as claimed in any one of claims 1 to 10, characterised in that the or each layer (13; 32; 42) of fluid cross-linkable polymer is formed with a width greater than the width of the metal strip (1) in order to coat all of the corresponding face of this metal strip (1).

13. Method of coating as claimed in any one of the preceding claims, characterised in that the cross-linkable polymer deposited in excess on the or each applicator roll (12; 30; 40) is removed.

14. Device for continuous coating of at least one face of a metal strip (1) with a cross-linkable polymer fluid film (20) obtained from precursors which are solid at room temperature and free of solvent or non-reactive diluent and whereof the softening temperature is higher than 50° C., the said film (20) having a thickness less than that of the metal strip (1), characterised in that it comprises:
means for continuous driving of the metal strip (1),
means for preheating the metal strip (1) to a temperature equal to or higher than the softening temperature of this cross-linkable polymer,
means (11) for forming, on an applicator roll (12) with a deformable surface and by forced flow at a temperature higher than the softening temperature of the cross-linkable polymer, a layer (13) of the said cross-linkable polymer in the molten state having a viscosity higher than 10 Pa.s under the conditions of formation of this layer,
means for driving the applicator roll (12) in rotation in the same direction as the direction of unwinding of the metal strip (1),
means for heating the applicator roll (12) to a temperature higher than the temperature of formation of the layer (13),
means (25) for thermally conditioning, in the course of the transfer of the layer (13) on the applicator roll (12), the cross-linkable polymer using methods adapted to lower the viscosity of this cross-linkable polymer to a value lower than the said viscosity measured under the conditions of the said forced flow,
means for compressing the metal strip (1) against the applicator roll (12) in order to effect a partial transfer in thickness of the layer (13) from this applicator roll (12) to a face of the metal strip (1), and
means (26) for separating the layer (13) into a part remaining on the applicator roll (12) and a part transferred to the corresponding face of the metal strip (1) in order to coat the said face with the said cross-linkable polymer and to obtain a coating with a homogeneous structured surface.

15. Device for coating as claimed in claim 14, characterised in that the means for compression of the metal strip (1) against the applicator roll (12) are formed by a support cylinder (5) with a deformable or non-deformable surface.

16. Device for coating as claimed in claim 14, characterised in that the means for compression of the metal strip (1) against the applicator roll (12) are formed by a second applicator roll (30) with a deformable surface which is driven in rotation in the opposite direction to the direction of unwinding of the strip (1), and that it comprises means (31) for forming on the second applicator roll (30), and by forced flow and at a temperature higher than the softening temperature of the cross-linkable polymer, a layer (32) of the said cross-linkable polymer in the molten state having a viscosity higher than 10 Pa.s under the conditions of formation of this layer (32), and means (33) for thermal conditioning, in the course of the transfer of the layer (32) on the second applicator roll (30), of the cross-linkable polymer using methods adapted to lower the viscosity of this cross-linkable polymer to a value lower than the said viscosity measured under the conditions of the said forced flow, a total transfer in thickness of this layer (32) to the other face of the metal strip being effected by the second applicator roll (30) in order to coat this face with a film (24) of cross-linkable polymer and to obtain a coating with a homogeneous thickness and a smooth surface.

17. Device for coating as claimed in claim 14, characterised in that the means for compression of the metal strip (1) against the applicator roll (12) are formed by a second applicator roll (40) with a deformable surface which is driven in rotation in the same direction as the direction of unwinding of the strip (1), and that it comprises means (41) for forming on the second applicator roll (40), and by forced flow and at a temperature higher than the softening temperature of the cross-linkable polymer, a layer (42) of the said cross-linkable polymer in the molten state having a viscosity higher than 10 Pa.s under the conditions of formation of this layer, and means (34) for thermal conditioning, in the course of the transfer of the layer (42) on the second applicator roll (40), of the cross-linkable polymer using methods adapted to lower the viscosity of this cross-linkable polymer to a value lower than the said viscosity measured under the conditions of the said forced flow, and means (46) for separating the layer (42) into a part remaining on the second applicator roll (40) and a part transferred to the other face of the metal strip (1) in order to coat this face with a film (44) of cross-linkable polymer and to obtain a coating with a homogeneous structured surface.

18. Device for coating as claimed in any one of claims 14 to 17, characterised in that the or each film (20; 24; 44) of cross-linkable polymer deposited on the corresponding face of the metal strip (1) by means of the or each applicator roll (12; 30; 40) is formed from a single-coat layer (13; 32; 42).

19. Device for coating as claimed in claim 17 or 18, characterised in that the or each film (20; 24; 44) of cross-linkable polymer deposited on the corresponding face of the metal strip (1) by means of the or each applicator roll (12; 30; 40) is formed from a multi-coat layer (13; 32; 42) comprising at least one primer coat and one top coat.

20. Device for coating as claimed in claim 19, characterised in that the top coat is thicker than the primer coat.

21. Device for coating as claimed in any one of claims 15 to 17, characterised in that the means for formation by forced flow of the or each layer (13; 32; 42) comprise at least one extrusion nozzle (11; 31; 41).

22. Device as claimed in claim 14 or 17, characterised in that it comprises means for adjustment of the temperature of the or each applicator roll (12; 40) in order to increase or decrease the thickness of the part of the or each layer (13; 42) transferred to the corresponding face of the metal strip relative to the part of the layer (13; 42) remaining on the or each roll (12; 40).

23. Device for coating as claimed in any one of claims 14, 17 or 22, characterised in that it comprises means for adjusting the tangential speed of the or each applicator roll (12; 40) in a ratio of between 0.5 and 2 times the speed of unwinding of the metal strip (1) in order to increase or decrease the thickness of the part of the or each layer (13; 42) transferred to the corresponding face of the metal strip (1) relative to the part of the layer (13; 42) on the or each applicator roll (12; 40).

24. Device for coating as claimed in any one of claims 14, 17 or 22, characterised in that the means (26; 46) for separation comprise a nozzle for suction of the filaments formed between the two parts of the layer (13; 42) or by a nozzle for blowing hot air in order to flatten the filaments on the applicator roll (12; 40) or by a transverse wire to break the said filaments, the said nozzles or the said wire extending over the entire width of the gap between the or each applicator roll (12; 40) and the metal strip (1).

25. Device for coating as claimed in any one of claims 14, 17, 22 or 24, characterised in that the excess of cross-linkable polymer is re-injected below the layer (13; 42) at the outlet of the extrusion nozzle (11; 41).

26. Device for coating as claimed in any one of claims 14 to 25, characterised in that the or each layer (13; 32; 42) of fluid cross-linkable polymer has a width less than the width of the metal strip (1) in order to coat only a part of this strip (1).

27. Device for coating as claimed in any one of claims 14 to 25, characterised in that the or each layer (13; 32; 42) of fluid cross-linkable polymer has a width greater than the width of the metal strip (1) in order to coat all of this metal strip (1).

28. Device for coating as claimed in any one of claims 14 to 27, characterised in that it comprises means (14) for removing the excess cross-linkable polymer deposited on the or each applicator roll (12; 30; 40).

29. Device for coating as claimed in claim 28, characterised in that the removal means are formed by at least one doctor blade (14) in contact with the or each corresponding applicator roll (12; 30; 40).

30. Device for coating as claimed in any one of claims 14 to 29, characterised in that the means for thermal conditioning of the cross-linkable polymer are formed by a system of heating of the or each applicator roll (12; 30; 40) and/or by at least one source (25; 33; 43) of application of a supplementary thermal flux to the or each layer (13; 32; 42).

31. Device for coating as claimed in claim 24, characterised in that the source (25; 33; 43) of application of the complementary thermal flux comprises hot air generators or infrared lamps or microwave systems.
